(19) United States
(12) Patent Application Publication
(10) Pub. No.: US 2003/0066029 A1
(43) Pub. Date: Apr. 3, 2003

(54) Virtual presentation system and method

(76) Inventor: Johnny W. Vizina, Sachse, TX (US)

Correspondence Address: Lawrence R. Youst, Danamraj & Youst, P.C., 12900 Preston Road, Suite 1200, LB 15, Dallas, TX, 75230-1328, US

(21) Appl. No.: 10/152,263

(22) Filed: May 21, 2002

Related U.S. Application Data
(60) Provisional application No. 60/326,544, filed on Oct. 2, 2001.

(51) Int. Cl. G06F 15/00

(52) U.S. Cl. 715/501.1; 715/530

(57) ABSTRACT

A system and method for creating, disseminating, and managing a digital multimedia presentation for promoting people, their capabilities, or products. As a tool for creating, disseminating, and managing a digital multimedia resume for a job candidate, resume-creating software is loaded on the candidate's computer, and is used to add multimedia presentation data regarding the candidate to the resume. Compatible resume-viewing software is loaded on a hiring manager's computer. The resume is electronically disseminated to a database that is searchable by the hiring manager. The hiring manager retrieves the candidate's resume from the database and uses the resume-viewing software to view the multimedia presentation data regarding the job candidate and to manage the review process.

### CROSS REFERENCE TO RELATED APPLICATION

This nonprovisional application claims priority from co-pending provisional Application No. 60/326,544 filed on, Oct. 2, 2001, entitled “Virtual Presentation System and Method.”

### TECHNICAL FIELD OF THE INVENTION

This invention relates to computer-generated multimedia presentation systems. More particularly, and not by way of limitation, the present invention is directed to a virtual presentation system and method for creating, disseminating, and managing a digital multimedia presentation for promoting people, their capabilities, or products.

### BACKGROUND OF THE INVENTION

Traditionally, people seeking employment have had to prepare their resume on paper and submit the resume to a company's hiring manager or a placement agency. In recent years, advancements in electronic communications have enabled many company Human Relations (HR) departments and placement agencies to accept text resumes from job applicants by e-mail. In addition, the advent of the global information network (i.e., Internet) has led to the creation of on-line job recruiting sites where employers can post job descriptions and requirements, and job candidates can post resumes or respond to job postings.

On-line job recruiting sites have the candidate prepare what may be called a “virtual resume”. In reality, however, the so called virtual resume is the paper resume which has been cut and pasted, and stored in electronic form. This is currently done by having on-line candidates data-fill an ASCII text form one page at a time, or attach their resume to an e-mail in a format such as Microsoft Word. Company HR departments may access the on-line job recruiting sites and perform keyword searches. Resumes of promising candidates may then be stored electronically or printed and stored in paper form. However, many of the tasks required to effectively handle the resume, and manage the review process must still be done manually.

For some types of jobs, such as acting, dancing, or singing jobs, the talents of the candidate need to be demonstrated to the hiring manager. Traditionally, this has been done through an auditioning process in which a number of candidates are invited to come to the office or studio of the hiring manager to demonstrate their talents. This is a very slow, cumbersome, and expensive process, requiring a great deal of time and expense for both the candidates and the hiring manager.

For people with other talents, such as artists, their talents also need to be demonstrated. Traditionally, this has been done by having the artist prepare a portfolio of the artist's works. Selected paintings, for example, that the artist feels are representative of his talents are assembled in a notebook. The artist then takes the portfolio with him to interviews where the works can be shown to the hiring manager. Once again, this is a very slow, cumbersome, and expensive process, requiring a great deal of time and expense for both the candidates and the hiring manager.

Additional situations arise in many contexts in which people need to present their capabilities and experience, to demonstrate their capabilities, or to show their creations to others. Existing methods for such presentations or demonstrations are manually intensive and time consuming.

In order to overcome the disadvantage of existing solutions, it would be advantageous to have a virtual presentation system and method for efficiently creating, disseminating, and managing a digital multimedia presentation for promoting people, their capabilities, or products. The present invention provides such a system and method.

### SUMMARY OF THE INVENTION

In one aspect, the present invention is directed to a method of creating a digital multimedia resume for a job candidate. The method includes the steps of loading resume-creating software on a computer; using the resume-creating software to add multimedia presentation data regarding the job candidate to the resume; and storing the resume in a form suitable for electronic dissemination to hiring personnel.

In another aspect, the present invention is directed to a method of creating, disseminating, and managing a digital multimedia resume for a job candidate. The method includes the steps of loading resume-creating software on a computer that is accessible by the job candidate; using the resume-creating software by the job candidate to add multimedia presentation data regarding the job candidate to the resume; loading on a computer accessible by a hiring manager, resume-viewing software that is compatible with the resume-creating software; and electronically disseminating the resume to the computer that is accessible by the hiring manager. The manager then uses the resume-viewing software to view the multimedia presentation data regarding the job candidate and to manage the review process.

In yet another aspect, the present invention is directed to a method of creating a digital multimedia presentation of a person's capabilities. The method includes the steps of loading presentation-creating software on a computer; using the presentation-creating software to add multimedia presentation data regarding the person's capabilities to the presentation; and electronically disseminating the presentation to interested parties. In one embodiment, the person is an artist, and the presentation includes digital images of artwork created by the artist. In another embodiment, the person is an entertainer, and the presentation includes a digital video of a performance by the entertainer.

In still yet another aspect, the present invention is directed to a method of creating a digital multimedia presentation regarding a product. The method includes the steps of loading presentation-creating software on a computer; using the presentation-creating software to add multimedia presentation data regarding the product to the presentation; and electronically disseminating the presentation to interested parties.

In still yet another aspect, the present invention is directed to a system for creating, disseminating, and managing a digital multimedia resume for a job candidate. The system includes a first computer that is accessible by the job candidate, and resume-creating software loaded on the first computer for creating the digital multimedia resume. The resume-creating software includes means for adding multimedia presentation data regarding the job candidate to the resume. The system also includes a second computer that is accessible by a hiring manager, and resume-viewing software loaded on the second computer for viewing and managing the digital multimedia resume. The resume-viewing software is compatible with the resume-creating software. A data network connects the first computer to the second computer for electronically disseminating the resume from the candidate to the hiring manager.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram of the preferred embodiment of the present invention when used as a virtual resume management tool;

FIG. 2 is a flow chart illustrating the steps of the overall method of the preferred embodiment of the present invention;

FIGS. 3A and 3B are portions of a flow chart illustrating the steps of a process by which a job candidate creates a multimedia virtual resume in accordance with the teachings of the present invention;

FIGS. 4A-4C are portions of a flow chart illustrating the steps of a process by which a hiring manager reviews and manages a plurality of multimedia virtual resumes in accordance with the teachings of the present invention; and

FIG. 5 is a flow chart illustrating the steps of a process by which the present invention de-conflicts direct resume submissions by candidates and submissions from placement agencies.

### DETAILED DESCRIPTION OF EMBODIMENTS

The present invention, referred to herein as a Virtual Viewer, is a virtual presentation system and method for creating, disseminating, and managing a digital multimedia presentation for promoting people, their capabilities, or products.

### Use as a Virtual Resume Management Tool

The Virtual Viewer is useful for corporate HR departments, recruiting firms, resume services, on-line job services, career consulting and management groups, and mid-to-senior-level portfolio managers. On-line job recruiting services can use the present invention to provide true virtual resumes rather than the resumes that are currently on line, which are essentially paper resumes that have been scanned in.

The Virtual Viewer combines the benefits of electronic communications, computerized database searching, and multimedia audio and visual presentations in the context of presenting people's experience and capabilities to others. When the present invention is used as a virtual resume management tool, there are two main user groups: job candidates and employers. There are also three distinct functions performed by the invention. The first is a tool used by job candidates to create a multimedia, audiovisual presentation style resume. The second is a resume exchange service with the capability to track and present the presentation style resume. The third is a tool used by employers to view the multimedia resumes and manage the resume review process.

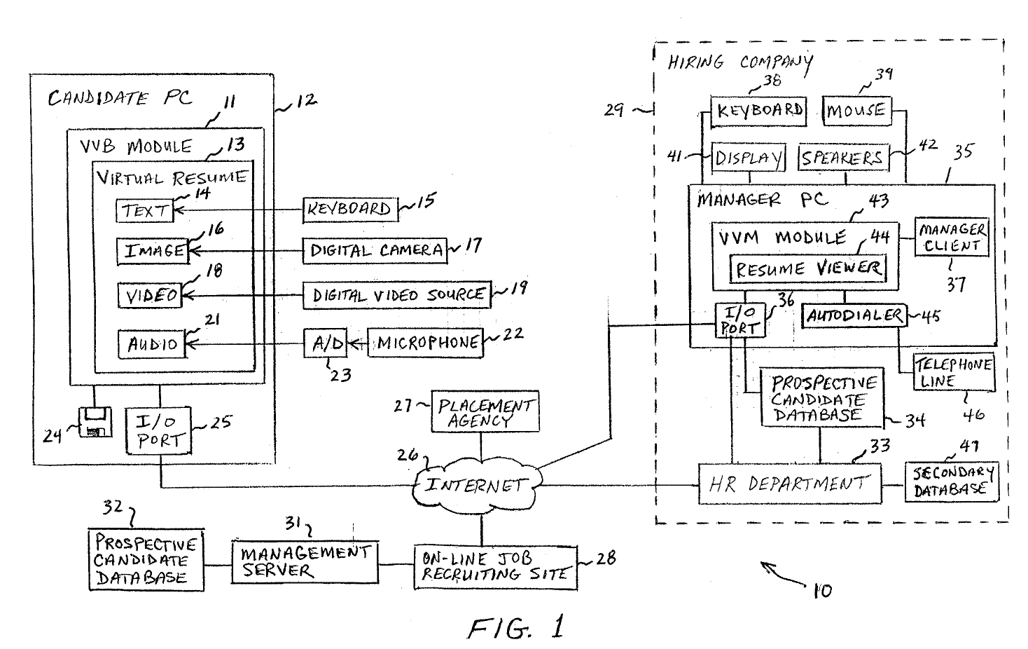

FIG. 1 is a simplified block diagram of an embodiment of the present invention when the Virtual Viewer 10 is used as a virtual resume management tool. A candidate searching for a job can download a Virtual Viewer Builder (VVB) software module 11, and install it on his own PC 12. He can then use the VVB software to prepare his own virtual resume 13 at home, with as much or as little background information as he desires. The candidate may include textual information 14 which may be input using a device such as a keyboard 15. He can also include digital imagery 16 such as a photograph of himself which is input from a device such as a digital camera 17. Video 18 may be added from a streaming video source 19 such as an off-board multimedia program. The candidate also has the option of using a prerecorded narration supplied with the VVB software, or adding his own audio narration 21 using a device such as a microphone 22 and analog-to-digital (A/D) converter 23.

The candidate can then store the virtual resume on a disk 24 or e-mail it through an input/output (I/O) port 25 to a number of destinations. For example, the virtual resume may be sent over the Internet 26 to a placement agency 27, an on-line job recruiting site 28, and/or directly to a hiring company 29. The on-line job recruiting site includes a management server 31 and a database of prospective candidates 32. When the candidate's virtual resume is received by the on-line job recruiting site, the resume is stored in the prospective candidate database. Alternatively, the candidate can take the virtual resume on the disk 24 directly to an interview with a hiring manager at the hiring company.

Within the hiring company 29, virtual resumes are generally received by a Human Relations (HR) Department 33 which stores the resumes in a searchable prospective candidate database 34. The HR Department may also maintain a secondary database 47 that is searchable only by the HR Department. Personnel in the HR Department can utilize a Virtual Viewer Corporate (VVC) software module to view and manage resumes in the databases, and send selected resumes to hiring managers in the company. A hiring manager can use his PC 35 to view the resumes and/or search the prospective candidate database 34 through I/O port 36. Alternatively, the manager can use a small downloadable client 37 to access the on-line job recruiting site 28 and search the candidate database 32. The manager may interface with the PC using a standard keyboard 38, mouse 39, display 41, and speakers 42.

The manager client 37 operates in the background on the manager's PC, monitoring his activities as he browses the Internet 26. When the hiring manager navigates through the on-line job recruiting site 28, the client software automatically identifies prospective employees that meet the manager's job description or specified candidate capabilities. As the manager navigates the site, the manager client communicates with the management server 31 to retrieve candidate resumes from the site database 32. Promising candidates can be identified and tagged while additional candidate resumes are reviewed.

Hiring managers can download or purchase a Virtual Viewer Manager (VVM) software module 43. The VVM software is a VVB-compatible program that includes a virtual resume viewer 44. The viewer enables the manager to view the candidate's virtual resume 13 on his PC 35 and manage virtual resumes at an integrated level. If the manager is interested in a candidate from the on-line job recruiting site 28, he can instruct the system to prepare a folder for the candidate and put the folder in the company's prospective candidate database 34. As discussed further below, the manager may also request that a communication be generated by the system to the candidate or, for example, the placement agency 27. Such communications may be e-mailed, sent by regular letter, or an autodialer 45 may dial the telephone number of the candidate or agency over telephone line 46.

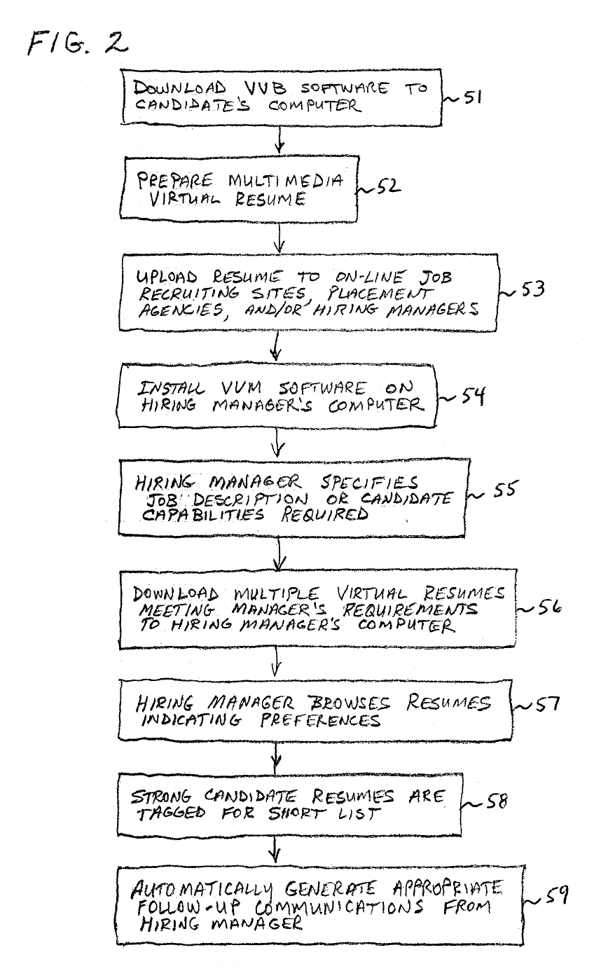

FIG. 2 is a flow chart illustrating the steps of the overall method of the preferred embodiment of the present invention. The method generally comprises the three functions of virtual resume creation, resume dissemination and exchange, and management of the resume review process. At step 51, a job candidate downloads the VVB software module 11 to the candidate's PC 12 from the Internet 26. At step 52, the candidate prepares his multimedia virtual resume 13, and at step 53, uploads the resume to one or more on-line job recruiting sites 28, placement agencies 27, and/or hiring managers at hiring companies 29.

At step 54, the VVM software module 43 is installed on the hiring manager's PC 35 so that the hiring manager can search the company's prospective client database 34 and review individual candidate folders. At step 55, the manager specifies a job description or the candidate capabilities that he desires. The search is performed, and at step 56, multiple virtual resumes meeting the manager's requirements are downloaded to the manager's PC. At step 57, the manager browses the resumes, indicating his candidate preferences. At step 58, strong (promising) candidates are tagged and added to a short list of candidates for the job. At step 59, the system automatically generates an appropriate follow-up communication from the hiring manager.

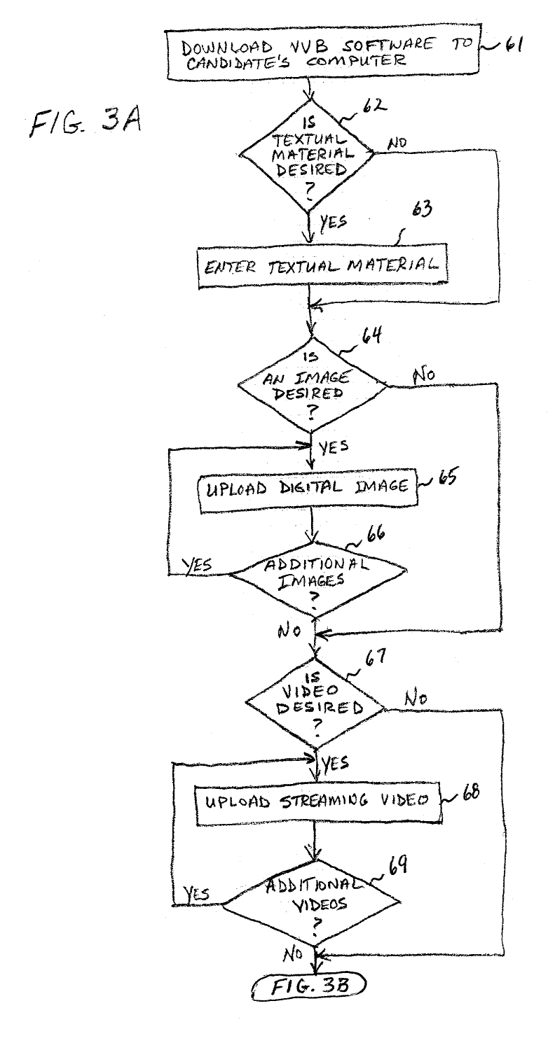

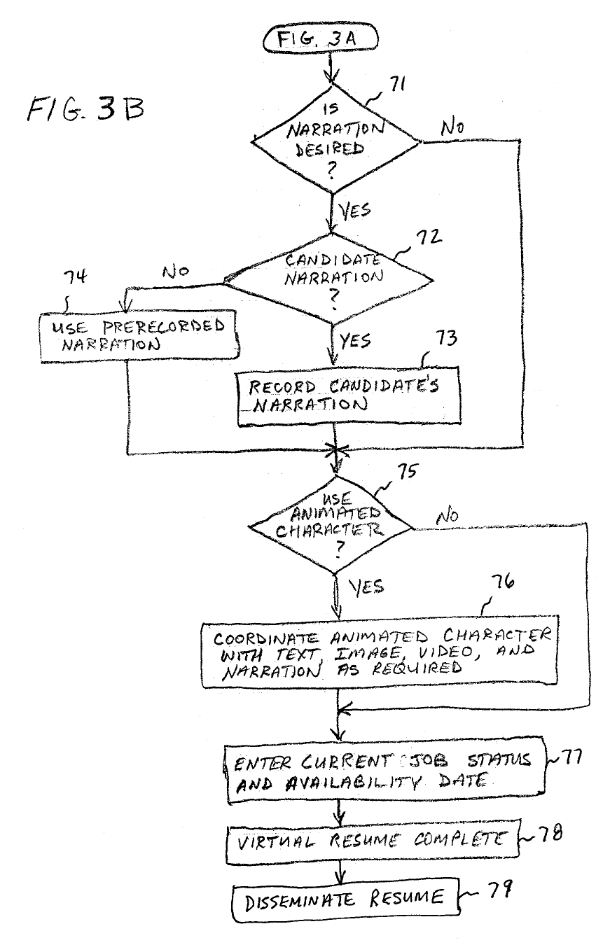

FIGS. 3A and 3B are portions of a flow chart illustrating the steps of a process by which a candidate creates a multimedia virtual resume in accordance with the teachings of the present invention. Referring first to FIG. 3A and FIG. 1, the process begins at step 61 where the VVB software module 11 is either downloaded to the candidate's PC 12, is purchased and installed, or the job candidate accesses a resume exchange service, and uses an online resume creation tool to create a virtual resume. At step 62, it is determined whether the candidate desires to input textual material 14. If so, the textual material is entered at step 63 using, for example, the keyboard 15. The textual information may also be entered online, or uploaded in XML format. If textual information is not desired, the process moves directly to step 64 where it is determined whether the candidate desires to input graphical data such as an image or photograph of the candidate 16. If so, the image is uploaded at step 65 using, for example, the digital camera 17. The graphical information, which is created using existing tools, may also include different types of multimedia information such as PowerPoint presentations. At step 66, it is then determined whether the candidate desires to input an additional image. If so, the process returns to step 65 where the additional image is uploaded. This cycle continues until all desired images have been input.

If no image is desired, or if all images have been input, the process moves to step 67 where it is determined whether the candidate desires to input digital video data 18. If so, the video data is uploaded at step 68 using, for example, the streaming video source 19. At step 69, it is then determined whether the candidate desires to input an additional video. If so, the process returns to step 68 where the additional video is uploaded. This cycle continues until all desired videos have been input. It should be noted that additional images and videos may be required if the candidate is, for example, an artist uploading images of his artwork, or an entertainer uploading videos of his performances.

The process then moves to FIG. 3B, step 71, where it is determined whether the candidate desires to input an audio narration 21 for the resume. If so, it is then determined at step 72 whether the candidate desires to record his own narration. If so, the candidate records his narration at 73 using, for example, the microphone 22 and A/D converter 23. If the candidate desires narration, but does not want to record his own, the process moves to step 74 where a prerecorded narration provided with the VVB software module 11 is utilized.

The process then moves to step 75 where it is determined whether the candidate desires to use an animated character provided with the VVB software module to lead a reviewing manager through the resume and inform the manager whether there is textual material 14, image(s) 16, video(s) 18, and audio (21). If so, the process moves to step 76 where the VVB software coordinates the character with the text, image, video, and narration as required. If not, the process moves directly to step 77 where the candidate is prompted to enter his current job status and date of availability. The process then moves to step 78 where the virtual resume is complete. At step 79, the resume is disseminated for review by hiring parties. The candidate can save the resume to the disk 24, e-mail the resume to the placement agency 27, or upload the resume to the on-line job recruiting site 28.

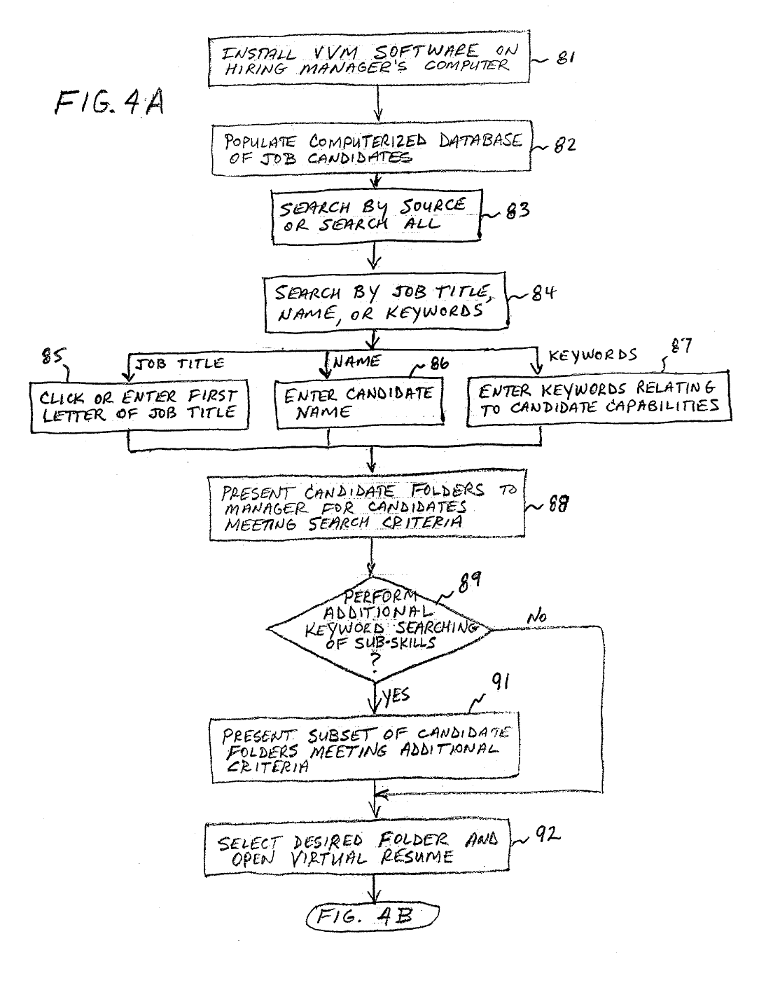

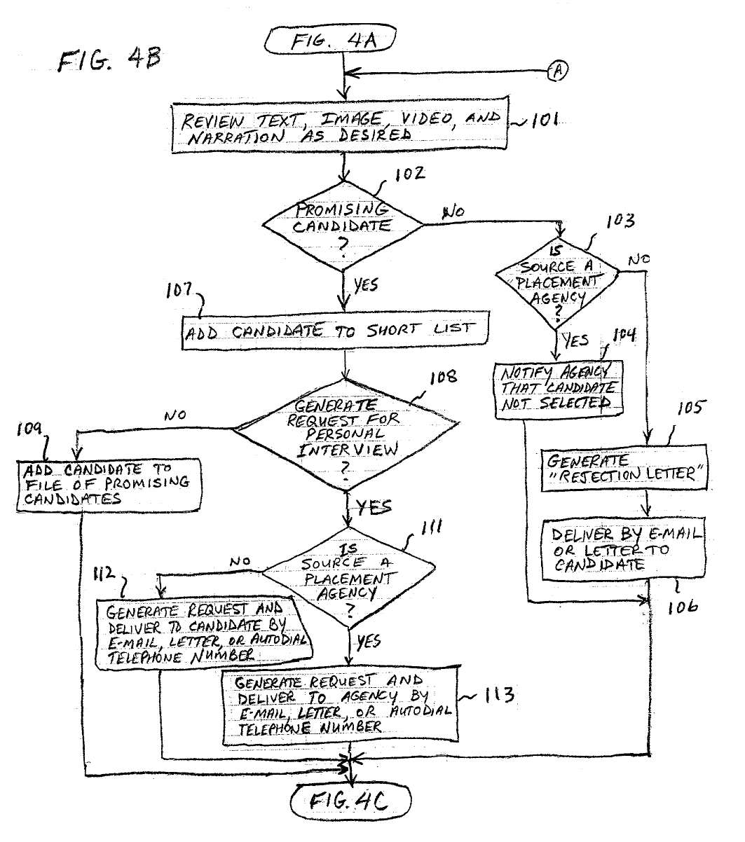

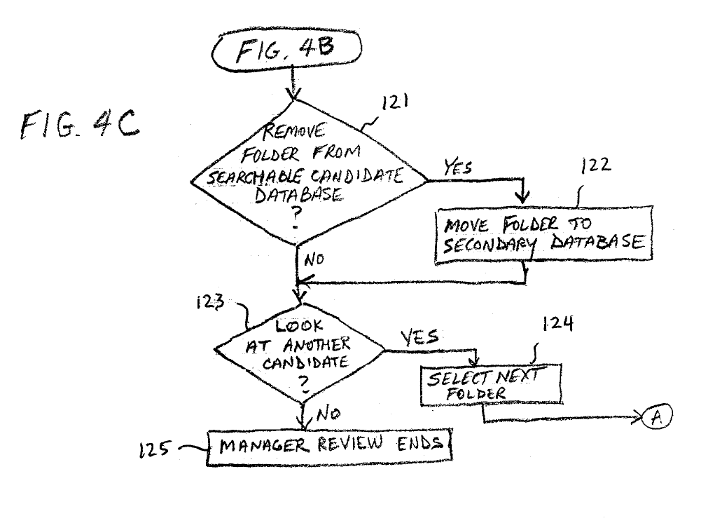

FIGS. 4A-4C are portions of a flow chart illustrating the steps of a process by which a hiring manager reviews and manages a plurality of multimedia virtual resumes in accordance with the teachings of the present invention. The Virtual Viewer system provides the manager with functionality that allows the manager to manage the resume review process. The management functionality also enables the manager to add information to the resume that will be used during the candidate selection process. This includes grading information and additional comments the manager may have.

Referring first to FIG. 4A and FIG. 1, the process begins at step 81 where the VVM software module 43 is installed on the manager's PC 35. At step 82, the company's prospective candidate database 34 is populated with a plurality of virtual resumes. Each candidate added to the company's prospective candidate database is described in a candidate folder.

At step 83, the manager indicates whether he desires to search the folders by source of the resume (e.g., direct from the candidate, or from a placement agency), or search all folders in the database. The VVM software enables the manager to indicate that he only wants to search folders of candidates who submitted their resumes directly to the company. The manager may alternatively indicate that he only wants to search folders of candidates that came through placement agencies or a particular placement agency. The database may be searched in any suitable manner, and at step 84, the manager indicates whether he desires to search, for example, by job title, by candidate name, or by keywords.

If the manager desires to search by job title, the process moves to step 85 where the VVM software enables the manager to enter the first letter of the job title that the manager needs to fill. Alternatively, the manager may use his mouse 39 to click on a tab indicating the first letter of the job title. For example, the manager may click on a tab labeled ‘D’ if he is looking for a Design Engineer. The program then brings up folders for all of the job candidates that are design engineers. Clicking on other letters causes the program to present the folders of candidates for other job descriptions. For example, ‘C’ may bring up the folders of Credit Managers, and ‘A’ may bring up Account Managers and Accountants. All of the job types that are applicable to the manager's company are included. The job types may be tailored to each individual company.

If the manager desires to search by candidate name, the process moves to step 86 where the VVM software enables the manager to enter the name of the candidate using, for example, his keyboard 38. The program then searches all candidate folders and retrieves the folder for the named candidate. If the manager desires to search by keywords, the process moves to step 87 where the VVM software enables the manager to enter keywords relating to the desired candidate capabilities. The program then searches all candidate folders and retrieves all the folders that contain the keywords.

At step 88, the program presents all of the candidate folders to the manager for candidates meeting the search criteria. At step 89, it is determined whether the manager desires to perform additional keyword searching of sub-skills. Any sub-skills or extra experiences that the candidate has, such as accounting, financial analyst, tax assessor, and office manager, are also listed in the folder, and the manager can also perform keyword searching of the sub-skills listed in the folders. If the manager desires to perform additional searching, the process moves to step 91 where a subset of the candidate folders meeting the additional criteria is presented to the manager. The process then moves to step 92 where the manager selects a desired folder and opens the virtual resume.

The process then moves to FIG. 4B, step 101, where the hiring manager reviews the text, image, video, and narration in the virtual resume as desired. In the preferred embodiment, the virtual resume may also include information such as a contact telephone number, an indexing number, and a current job status and availability date. If the resume came from a placement agency, the contact telephone number is the telephone number of the agency. If the resume was a direct submission from a candidate, the contact number is the telephone number of the candidate. The indexing number is used by the program to uniquely identify each virtual resume and its source. The date of availability may be put in the folder by the candidate or by a placement agency. When the hiring manager calls up the candidate's folder, the manager can see whether the candidate is currently employed and when the candidate will be available for hiring. For privacy reasons, the name of the current employer may be omitted. The current job status is updated if the candidate is hired. For example, if the candidate is hired full time, and later goes to interview at another company, his folder will indicate that he is employed full time.

Resumes may be reviewed utilizing any generally available multimedia player. In one embodiment, the manager can click on the candidate's photograph 16, and the program presents the video clip 18 prepared by the candidate that describes or demonstrates the candidate's qualifications. As noted above, an animated character may also be selected to lead the hiring manager through the resume. At any time, the manager can make comments regarding his evaluation of each candidate, and these comments are stored in a confidential area of the candidate's folder.

At step 102, the manager decides whether the candidate is a promising candidate. If not, the process moves to step 103 where it is determined whether the source of the resume is a placement agency. If so, the program generates a communication at step 104 that notifies the agency that the candidate has not been selected. The manager may elect to send the communication by e-mail, regular letter, or by having the Virtual Viewer system autodial the contact telephone number. If the source was not a placement agency, i.e., the resume was a direct submission from a candidate, the process moves to step 105 where the Virtual Viewer generates a “rejection letter” thanking the candidate for his interest and informing him that an offer cannot be made at that time. The rejection letter may be delivered at step 106 by e-mail or regular letter to the candidate.

However, if at step 102 the hiring manager decided that the candidate is a promising candidate, the process moves to step 107 where the promising candidate is added to a short list of promising candidates. The manager can then quick-view all of the candidates that he has interviewed and added to the short list. Information provided in the short list can be tailored by the manager to include only the information that he thinks is required. For example, the short list may be limited to the candidates names, the job title, and the indexing number. At step 108, it is then determined whether to generate a request for a personal interview. If the manager does not desire a personal interview at that time, the process moves to step 109 where the candidate is added to a file of promising candidates. If the manager feels that the candidate is a good candidate, but is just not right for the current opening, a communication may optionally be generated to the candidate or his agency stating that the company may call them at a future date if another opportunity becomes available.

However, if the manager indicates at step 108 that he wants to request a personal interview, the process moves to step 111 where it is determined whether the source of the resume was a placement agency. If not, the process moves to step 112 where the Virtual Viewer generates a request for a personal interview which is delivered to the candidate by e-mail, regular letter, or by autodialing the candidate's contact telephone number, as desired. The manager may use headphones connected directly to the PC for telephone calls. The call may be a Voice over IP (VoIP) call. Alternatively, an e-mail may be immediately sent to the candidate. This is useful if the manager is on line, and a phone line is not available. If, at step 111, the source of the resume was a placement agency, however, the process moves to step 113 where the Virtual Viewer generates a request for a personal interview which is delivered to the agency by e-mail, regular letter, or by autodialing the agency's contact telephone number, as desired.

Following steps 104, 106, 109. 112, or 113, the process moves to FIG. 4C, step 121, where it is determined whether to remove the candidate's folder from the searchable candidate database 34. This may be desirable, for example, if the candidate was obviously unsatisfactory for the company, or if the hiring manager is very certain that he will hire the candidate, and the HR Department 33 does not want other managers in the company requesting that offers go out to the candidate. If it is desired to remove the candidate's folder from the searchable candidate database, the candidate's folder is moved at step 122 to the secondary database 47 which is searchable only by the HR Department.

Following steps 121 or 122, the process moves to step 123 where the hiring manager indicates whether he wants to look at another candidate folder. If so, the next folder is selected at step 124, and the process returns to step 101 of FIG. 4A where the manager begins the review process for the new folder. If the manager does not desire to look at another candidate folder, the manager review process ends at step 125.

Thus, thee present invention brings the candidate's expertise, achievements, educational background, and portfolio information to the desktop in a virtual multimedia application. The Virtual Viewer launches an indexed design configuration for easy access and storage of information, and it provides indexed categories of the candidate's expertise and background in an ASCII text format with keyword summary capabilities.

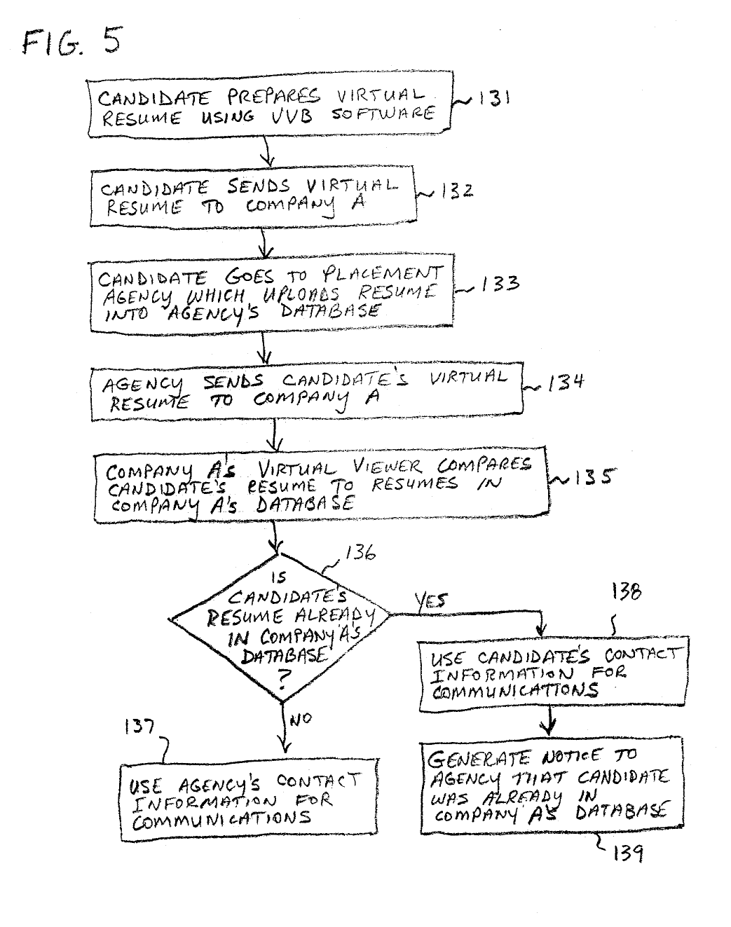

FIG. 5 is a flow chart illustrating the steps of a process by which the present invention de-conflicts direct resume submissions by candidates and submissions from placement agencies. At step 131, the candidate prepares his virtual resume on his own PC 12 using the VVB software module 11. At step 132, the candidate then sends his virtual resume directly to Company A. At step 133, the candidate then goes to a placement agency 27 that also builds virtual resumes using the present invention. The candidate can be added to the agency's list of candidates by uploading his virtual resume into the agency's database. Alternatively, if a candidate does not have a virtual resume, the placement agency can create a virtual resume with the agency's private label. The candidate gets a copy, and the resume is added to the agency's database.

At step 134, the agency may send the candidate's virtual resume to Company A because the agency has an indication that Company A is looking for someone with the candidate's qualifications, and the agency does not know that the candidate has already sent his resume to Company A directly. When the candidate's resume is received by Company A, Company A's Virtual Viewer system compares the candidate's resume at step 135 to those that are already stored in Company A's database. The system may make this comparison by using, for example, the unique indexing number that is assigned to each virtual resume when it is created. If the candidate created his own resume, sent it directly to Company A, and then uploaded it at the placement agency, the indexing number of the direct resume will match the indexing number of the agency resume. However, if the agency created an entirely new resume for the candidate, the indexing number may be different. Therefore, the system may also compare keywords or candidate names to determine whether duplicate resumes are received.

At step 136, it is determined whether the candidate's virtual resume was already in Company A's database. If not, the agency is credited with the resume, and at step 137, any communications that are generated by the system are sent to the agency using the agency's contact information. However, if the candidate's virtual resume was already in Company A's database, the process moves to step 138 where the candidate's contact information, rather than the agency's contact information, is used for any communications that are generated by the system. At step 139, a notice may be automatically generated to the placement agency to inform them that the candidate was already in Company A's database. It should be noted that this process also works in reverse, that is, if the agency sends a candidate's resume to the company first, and then the candidate presents his resume, the program indicates the contact number for the agency on the candidate's folder rather than the candidate's contact number. A notice may be automatically generated to the candidate to inform him that his resume had already been received from the placement agency.

This solves the problems that arise when a placement agency believes that they sent a candidate to the company first, and that a fee should be paid by the company if the candidate is hired. Sometimes, a company will not make an offer to a candidate, even if the candidate approached them first, if the company subsequently received the candidate's resume from an agency. This may occur because the company does not want to pay the agency's fee, or does not want to get into a controversy with the agency over which event occurred first. The program solves this problem by indicating on the candidate's folder, the contact number for either the candidate or the agency, depending on which was first to add the candidate's resume to the company's database. The folders may also be time-stamped with the time and date of receipt thus eliminating any controversy.

The Virtual Viewer may also indicate whether some information in the folder such as reference information or educational degrees have been verified. For example, if an agency has performed these verifications, then the company HR department does not have to repeat this process when they receive a folder from the agency.

The invention may also be used in combination with conferencing software that allows managers in two different locations to view the folder of a promising candidate. A whiteboard application may also be combined so that notations can be made and shared by the two managers.

The Virtual Viewer software is compatible with all software languages and operating systems such as Unix, Oracle®, Windows NT®, etc. The system software uses java scripting and database engineering. The resume exchange and resume review functionality is preferably implemented with a browser-based solution. The resume creation process may also be implemented using a browser-based tool in conjunction with existing desktop tools that are known to those skilled in the art.

### Other Uses of the Invention

Artists can use the present invention to present a portfolio of their artwork. Instead of creating a physical portfolio of selected works, the artist can prepare a virtual portfolio which is included in the graphical data in the virtual resume created by the Virtual Viewer. The virtual resume and portfolio can then be disseminated to galleries or hiring managers as appropriate and desired. The present invention may also be utilized by students applying to colleges or other schools, and by the schools to choose the best candidates for admission. Aspiring actors or other performers can also use the present invention to present an audition tape of themselves. Instead of physically going to an audition at the office or studio of the hiring manager, the actor or performer can prepare a virtual audition tape that is included in the video data in the virtual resume created by the Virtual Viewer. The virtual resume and audition tape can then be disseminated to studios or hiring managers as appropriate and desired.

Companies in the entertainment industry such as major record labels can use the Virtual Viewer to create a database of performers. Executives can then search the database by, for example, music type. The folder contains details of the performer's talents (e.g., songwriter, singer, pianist, etc.). Clicking on the performer's photograph may bring up, for example, an audio-video clip of the performer performing on stage. The executive has the same options that the hiring manager has when the invention is used for reviewing and managing candidate resumes, including identifying promising candidates, creating a short list, entering comments, and the like.

The present invention may also be utilized to promote products rather than people. For example, in a business that sells and trades automobiles, a “virtual resume” can be prepared for a particular car, including an audiovisual clip of the car while driving. In a similar manner, auction houses can use the present invention to prepare preview materials for bidders at a live or on-line auction. Likewise, real estate agents can use the Virtual Viewer to store and show video clips of properties that are on the market. The present invention enhances the ability to sell practically any product “that must be seen to be appreciated”.

It is thus believed that the operation and construction of the present invention will be apparent from the foregoing description. While the method, apparatus and system shown and described has been characterized as being preferred, it will be readily apparent that various changes and modifications could be made therein without departing from the scope of the invention as defined in the following claims.

What is claimed is:

1. A method of creating a digital multimedia resume for a job candidate, said method comprising the steps of:
loading resume-creating software on a computer;
using the resume-creating software to add multimedia presentation data regarding the job candidate to the resume; and
storing the resume in a form suitable for electronic dissemination to hiring personnel.

2. The method of creating a digital multimedia resume of claim 1 wherein the step of loading resume-creating software on a computer includes downloading the resume-creating software from a worldwide information network.

3. The method of creating a digital multimedia resume of claim 2 wherein the step of downloading the resume-creating software from a worldwide information network includes downloading the resume-creating software from an on-line job recruiting site.

4. The method of creating a digital multimedia resume of claim 1 wherein the step of using the resume-creating software to add multimedia presentation data to the resume includes adding textual and graphical data to the resume, said graphical data including at least one digital image.

5. The method of creating a digital multimedia resume of claim 4 wherein the step of adding textual and graphical data to the resume includes adding a digital image of the job candidate.

6. The method of creating a digital multimedia resume of claim 1 wherein the step of using the resume-creating software to add multimedia presentation data to the resume includes adding video data to the resume, said video data demonstrating a capability of the job candidate.

7. The method of creating a digital multimedia resume of claim 1 wherein the step of using the resume-creating software to add multimedia presentation data to the resume includes adding audio data to the resume, said audio data providing a narration for the resume.

8. The method of creating a digital multimedia resume of claim 1 wherein the step of storing the resume in a form suitable for electronic dissemination to hiring personnel includes storing the resume in a file suitable for e-mailing to hiring personnel.

9. The method of creating a digital multimedia resume of claim 1 wherein the step of storing the resume in a form suitable for electronic dissemination to hiring personnel includes storing the resume on a diskette that can be uploaded to a computer at a hiring company.

10. A method of creating, disseminating, and managing a digital multimedia resume for a job candidate, said method comprising the steps of:
loading resume-creating software on a computer that is accessible by the job candidate;
using the resume-creating software by the job candidate to add multimedia presentation data regarding the job candidate to the resume;
loading on a computer accessible by a hiring manager, resume-viewing software that is compatible with the resume-creating software;
electronically disseminating the resume to the computer that is accessible by the hiring manager; and
using the resume-viewing software by the hiring manager to view the multimedia presentation data regarding the job candidate.

11. The method of creating, disseminating, and managing a digital multimedia resume of claim 10 wherein the hiring manager receives a plurality of multimedia resumes from a plurality of job candidates, and the method further comprises, before the step of viewing the multimedia presentation data, the steps of:
storing the plurality of multimedia resumes in a prospective candidate database;
searching the database for a suitable candidate meeting specified search criteria; and
retrieving the multimedia resume of the suitable candidate from the database and sending the retrieved resume to the computer that is accessible by the hiring manager.

12. The method of creating, disseminating, and managing a digital multimedia resume of claim 11 wherein the step of searching the database for a suitable candidate includes searching the database based on a job title.

13. The method of creating, disseminating, and managing a digital multimedia resume of claim 11 wherein the step of searching the database for a suitable candidate includes searching the database based on at least one keyword entered by the hiring manager.

14. The method of creating, disseminating, and managing a digital multimedia resume of claim 11 further comprising creating a short list of promising candidates, said short list being maintained separately from the prospective candidate database.

15. The method of creating, disseminating, and managing a digital multimedia resume of claim 11 further comprising the steps of:
identifying a promising candidate from the plurality of job candidates; and
automatically determining whether the promising candidate's resume came from a placement agency or directly from the promising candidate.

16. The method of creating, disseminating, and managing a digital multimedia resume of claim 15 further comprising the steps of:
automatically generating a communication to the placement agency, upon determining that the promising candidate's resume came from a placement agency; and
automatically generating a communication to the promising candidate, upon determining that the promising candidate's resume came directly from the promising candidate.

17. The method of creating, disseminating, and managing a digital multimedia resume of claim 16 wherein the steps of automatically generating a communication include automatically generating an e-mail message addressed to an e-mail address provided in the resume.

18. The method of creating, disseminating, and managing a digital multimedia resume of claim 16 wherein the steps of automatically generating a communication include automatically dialing a contact telephone number provided in the resume.

19. The method of creating, disseminating, and managing a digital multimedia resume of claim 11 further comprising the steps of:
identifying an unacceptable candidate from the plurality of job candidates; and
automatically determining whether the unacceptable candidate's resume came from a placement agency or directly from the unacceptable candidate.

20. The method of creating, disseminating, and managing a digital multimedia resume of claim 19 further comprising the steps of:
automatically generating a communication to the placement agency, upon determining that the unacceptable candidate's resume came from a placement agency; and
automatically generating a communication to the unacceptable candidate, upon determining that the unacceptable candidate's resume came directly from the unacceptable candidate.

21. A method of creating a digital multimedia presentation of a person's capabilities, said method comprising the steps of:
loading presentation-creating software on a computer;
using the presentation-creating software to add multimedia presentation data regarding the person's capabilities to the presentation; and
electronically disseminating the presentation to interested parties.

22. The method of creating a digital multimedia presentation of claim 21 wherein the step of using the presentation-creating software to add multimedia presentation data to the presentation includes adding textual and graphical data to the presentation, said graphical data including at least one digital image.

23. The method of creating a digital multimedia presentation of claim 22 wherein the person is an artist, and the digital image is an image of artwork created by the artist.

24. The method of creating a digital multimedia presentation of claim 21 wherein the person is an entertainer, and the step of using the presentation-creating software to add multimedia presentation data to the presentation includes adding digital video data to the presentation, said video data including a video clip of at least a portion of a performance by the entertainer.

25. A method of creating a digital multimedia presentation regarding a product, said method comprising the steps of:
loading presentation-creating software on a computer;
using the presentation-creating software to add multimedia presentation data regarding the product to the presentation; and
electronically disseminating the presentation to interested parties.

26. A system for creating, disseminating, and managing a digital multimedia resume for a job candidate, said system comprising:
a first computer that is accessible by the job candidate;
resume-creating software loaded on the first computer for creating the digital multimedia resume, said resume-creating software including means for adding multimedia presentation data regarding the job candidate to the resume;
a second computer that is accessible by a hiring manager;
resume-viewing software loaded on the second computer for viewing and managing the digital multimedia resume, said resume-viewing software being compatible with the resume-creating software; and
a data network connecting the first computer to the second computer, said data network electronically disseminating the resume from the candidate to the hiring manager.

27. The system for creating, disseminating, and managing a digital multimedia resume of claim 26 further comprising a database of digital multimedia resumes connected to the data network, and wherein the data network includes means for storing the candidate's resume in the database.

28. The system for creating, disseminating, and managing a digital multimedia resume of claim 27 wherein the database includes means for searching the database for a suitable candidate that meets search criteria specified by the hiring manager.

29. The system for creating, disseminating, and managing a digital multimedia resume of claim 29 further comprising means for automatically generating a communication from the hiring manager to the suitable candidate.
